(19) United States
(12) Patent Application Publication
(10) Pub. No.: US 2019/0235854 A1
(43) Pub. Date: Aug. 1, 2019

(54) METHOD AND SYSTEM FOR DEVELOPING A NEW VERSION OF SOFTWARE OF AN AVIONICS COMPUTER

(71) Applicant: Airbus Operations SAS, Toulouse (FR)

(72) Inventors: Arnaud CHEVALIER, BLAGNAC (FR); Hacen ABDESLEM, TOULOUSE (FR)

(21) Appl. No.: 16/251,497

(22) Filed: Jan. 18, 2019

(30) Foreign Application Priority Data
Jan. 26, 2018 (FR) 1850616

(51) Int. Cl. G06F 8/65; G06F 8/61; G06F 17/50

(52) U.S. Cl. CPC G06F 8/65; G06F 17/5022; G06F 8/61

(57) ABSTRACT

An aircraft avionics computer is equipped with a current software version comprising a set of interconnected functions. A function to be updated of the set of functions, receives, as input, function outputs of a first subset of functions of the set of functions and provides an output linked to a first input of a switch. Developing a new version of the avionics computer software comprises connecting to the avionics computer an external computer of which software comprises a new version of the function to be updated; receiving, by the new function version, function outputs of the first subset of functions; dispatching the output of the function to be updated to a second switch input; controlling the switch such that in a normal mode of operation, the switch output corresponds to the first input and in a fine-tuning mode of operation, the switch output corresponds to the second input.

### CROSS-REFERENCES TO RELATED APPLICATIONS

This application claims the benefit of the French patent application No. 1850616 filed on Jan. 26, 2018, the entire disclosures of which are incorporated herein by way of reference.

### BACKGROUND OF THE INVENTION

The present invention relates to the development of the software embedded in the avionics computers of aircraft. Such an avionics computer comprises inputs and outputs that may be of on or off type, analogue type, digital type, etc. These inputs and these outputs may correspond to physical inputs or outputs of the avionics computer, or else form the subject of an acquisition or of a transmission by means of communication buses, for example to the ARINC 429 or 664 standards, part 7. The avionics computer implements a set of functions in such a way as to compute the outputs as a function of the inputs. These functions are generally mutually interconnected, an output of one function then being able to correspond to an input of another function. The various functions are implemented by the software of the avionics computer. It is sometimes necessary to develop a new version of the software, in particular during upgrades of the aircraft's equipment, such as for example actuators, during modifications of interfaces of the avionics computer, when the specifications of functions are modified (for example to modify the behavior of the aircraft), etc. The development of a new version of the software generally requires several intermediate versions of the software, called “standards”: for example, standard 1, then standard 2 . . . standard N (N being an integer number). Each standard is delivered to the manufacturer of the aircraft, then tested on a test bench and optionally on the aircraft so as to verify its compliance with respect to the expected behavior of the avionics computer. If it is not fully satisfactory, the specifications are modified, and a new standard is produced and then tested. This gives rise to a long and expensive process. Indeed, the development of a new standard entails a rigorous and complex process, so as to satisfy the demands of the air certification authorities. It would be desirable to simplify the process of developing a new version of the software, in particular by reducing the number of necessary standards.

### SUMMARY OF THE INVENTION

The aim of the present invention is, in particular, to afford a solution to this need. It relates to a method for developing a new version of software of an avionics computer of an aircraft,

the avionics computer being equipped with a current version of the software;

the software comprising a set of functions interconnected together and also with inputs and outputs of the avionics computer.

The method is noteworthy in that one of the functions of the set of functions being termed the function to be updated, the function to be updated receives, as input, outputs of functions of a first subset of functions of the set of functions and provides at least one output linked to a first input of a switch, of which an output is linked to one or more inputs of functions of a second subset of functions of the set of functions,

and in that it comprises the following steps:

hooking up to the avionics computer an external computer equipped with software comprising a new version of the function to be updated;

receiving, by the new version of the function to be updated implemented by the external computer, the outputs of functions of the first subset of functions;

dispatching, from the new version of the function to be updated implemented by the external computer, the at least one output of the function to be updated to a second input of the switch;

controlling the switch in such a way that:

in a first mode of operation, termed normal, the output of the switch corresponds to the first input; and

in a second mode of operation, termed fine tuning, the output of the switch corresponds to the second input.

This method thus makes it possible to implement in the external computer a version to be tested of the software of the function to be updated and to test the avionics computer with this version of the function to be updated, without requiring the development of a new standard. The implementation, in the external computer, of the version to be tested of the software of the function to be updated is easy and fast, thereby making it possible to carry out successively tests of several versions of the software of the function to be updated until a version corresponding to the expected behavior of the function to be updated is obtained. This version, whose behavior is already validated, can then be included in a new standard of the software of the avionics computer.

In one embodiment, in the step comprising hooking up the avionics computer to the external computer, the external computer is hooked up to outputs of the avionics computer corresponding to outputs of functions of the first subset of functions.

In another embodiment, the method furthermore comprises the following steps:

dispatching, by the external computer, a request destined for the avionics computer, to request the dispatching of information corresponding to at least one output from among the outputs of functions of the first subset of functions;

in response to the request, dispatching, by the avionics computer, of the information corresponding to the at least one output, destined for the external computer;

receiving, by the external computer, the information corresponding to the at least one output.

According to a first alternative, the avionics computer and the external computer are installed on a test bench.

According to a second alternative, the avionics computer and the external computer are installed aboard an aircraft.

The invention also relates to a system for developing a new version of software of an avionics computer of an aircraft, the system comprising the avionics computer, equipped with a current version of the software, the software comprising a set of functions interconnected together and also with inputs and outputs of the avionics computer.

The system is noteworthy in that it furthermore comprises a switch and a computer external to the avionics computer, and in that:

the avionics computer is configured in such a way that one of the functions of the set of functions, termed the function to be updated, receives, as input, outputs of functions of a first subset of functions of the set of functions and provides at least one output linked to a first input of the switch of which an output is linked to one or more inputs of functions of a second subset of functions of the set of functions,

the external computer is equipped with software comprising a new version of the function to be updated, it is hooked up to the avionics computer and it is configured to:

receive, by the new version of the function to be updated implemented by the external computer, the outputs of functions of the first subset of functions;

dispatch, from the new version of the function to be updated implemented by the external computer, the at least one output of the function to be updated to a second input of the switch;

the system is furthermore configured to control the switch in such a way that:

in a first mode of operation, termed normal, the output of the switch corresponds to the first input; and

in a second mode of operation, termed fine tuning, the output of the switch corresponds to the second input.

In one embodiment, the external computer is hooked up to outputs of the avionics computer corresponding to outputs of functions of the first subset of functions.

In another embodiment:

the external computer is furthermore configured to dispatch a request destined for the avionics computer, to request the dispatching of information corresponding to at least one output from among the outputs of functions of the first subset of functions; and

the avionics computer is configured to dispatch information corresponding to the at least one output, destined for the external computer, in response to the request.

According to a first alternative, the system is installed on a test bench.

According to a second alternative, the system is installed aboard an aircraft.

### BRIEF DESCRIPTION OF THE DRAWINGS

The invention will be better understood on reading the description which follows and on examining the appended figures.

FIGS. 1 and 2 illustrate in schematic manner two particular embodiments of a system for developing a new version of software of an avionics computer of an aircraft, in accordance with the invention.

### DETAILED DESCRIPTION OF THE PREFERRED EMBODIMENTS

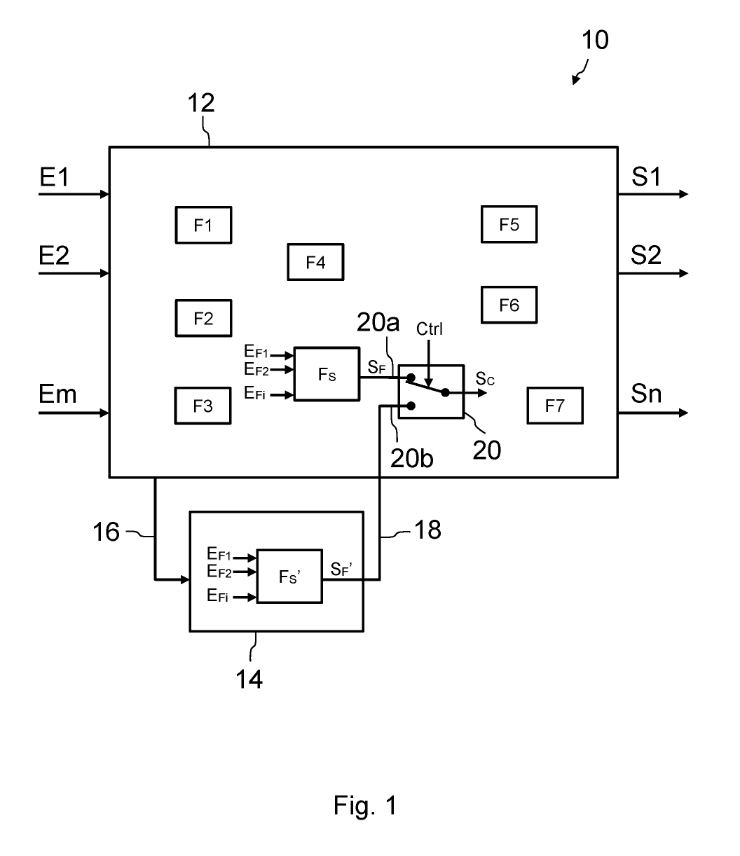

The system 10 for developing a new version of software of an avionics computer of an aircraft represented in FIG. 1 comprises the avionics computer 12, as well as a computer 14 external to the avionics computer. The avionics computer 12 comprises a set of inputs E1, E2 . . . Em which may originate from other avionic computers of the aircraft, sensors of the aircraft, etc. It also comprises a set of outputs S1, S2, . . . Sn which may be linked to other avionic computers of the aircraft, to actuators of the aircraft, etc. The avionics computer 12 comprises a set of functions F1, F2, . . . F7, Fs implemented in a software manner by software of the avionics computer 12. The function Fs is a function for which it is desired to effect an update. It is called the function to be updated in the subsequent description. The software of the avionics computer 12 corresponds to a current version of the software, which implements a current version of the function Fs. The function Fs receives a set of inputs EF1, EF2, . . . EFi originating from outputs of functions of a first subset of the set of functions and/or inputs of the avionics computer 12. It produces at least one output SF. The avionics computer 12 also comprises a switch 20, implemented for example but not necessarily in a software manner The output SF is linked to a first input 20a of the switch. The switch 20 comprises at least one output SC which is linked to one or more inputs of functions of a second subset of functions of the set of functions of the avionics computer 12. The external computer 14 is linked at input to the avionics computer 12 by at least one link 16 and it is linked at output to the avionics computer 12 by a link 18. The external computer 14 comprises a new version FS′ of the function to be updated FS. Like the function Fs, the function FS′ receives the set of inputs EF1, EF2, . . . EFi. These inputs are received by the external computer 14, from the avionics computer 12, via the link 16. The function FS′ produces at least one output SF′. This output is linked to a second input 20b of the switch 20 via the link 18. The switch 20 comprises a control input Ctrl. According to the state of the control input, the output SC of the switch corresponds either to the first input 20a, or to the second input 20b.

In operation, the system can be configured according to a mode of operation termed normal or according to a mode of operation termed fine tuning. In the normal mode of operation, the control signal Ctrl of the switch 20 is controlled in such a way that the output SC of the switch corresponds to the first input 20a, that is to say to the current version of the function FS. The avionics computer 12 thus operates in accordance with the current software version installed in the computer. In the fine-tuning mode of operation, the control signal Ctrl of the switch 20 is controlled in such a way that the output SC of the switch corresponds to the second input 20b, that is to say to the new version FS′ of the function FS. The avionics computer 12 thus operates as if this new version FS′ of the function FS were incorporated into the software of the computer. Consequently, the fine-tuning mode of operation makes it possible to test the new version FS′ of the function FS without modifying the current version of the software installed in the avionics computer 12. Thus, it is not necessary to wait for a new standard of the avionics computer 12 to test this new version of the function FS. The external computer 14 not being an avionics computer, its software can be modified rapidly without constraint, thereby making it possible to test several successive versions of the function FS until a satisfactory version is arrived at which can then be integrated into a new standard of the avionics computer. The probability that the version of the function FS integrated into the new standard is satisfactory is much higher than if this version had not been tested beforehand by virtue of the external computer 14. The invention therefore allows a significant reduction in the development times and costs for a new version of the software of the avionics computer.

In an advantageous manner, the new version FS′ of the function FS is tested while the avionics computer 12 is installed on a test bench (on the ground) simulating the operation of an aircraft. This makes it possible to test and to fine tune this new version without risk for an aircraft. When a version of the function thus tested on the test bench corresponds to the expected specifications, the avionics computer 12 (as well as the external computer 14 which is hooked up to it), can be installed aboard an aircraft so as to test this new version of the function FS under real conditions. Preferably, during takeoff and landing of the aircraft, the avionics computer 12 is configured in the normal mode of operation corresponding to the current version of its software. This avoids taking risks during these takeoff and landing phases. During flight phases that are less critical for the aircraft, for example during cruising flight, the avionics computer 12 is configured in the fine-tuning mode of operation so as to test the new version of the function FS under real conditions during the flight of the aircraft.

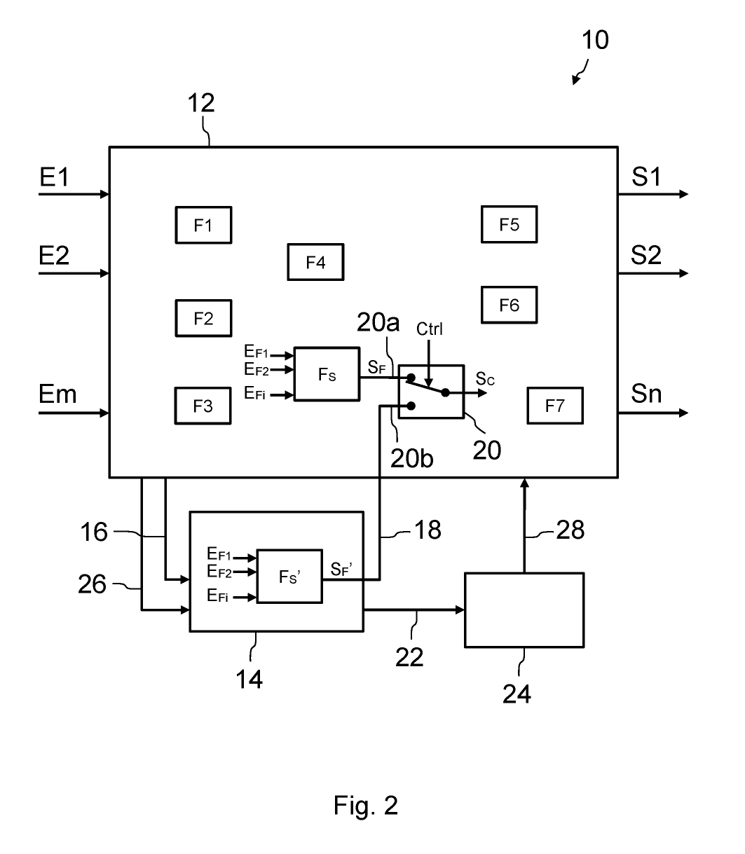

In a particular embodiment represented in FIG. 2, the system 10 furthermore comprises a computer 24. This computer 24 is linked at input to an output of the external computer 14 by a link 22. It is also linked at output to an input of the avionics computer 12 by a link 28. The external computer 14 is furthermore linked to the avionics computer 12 by a link 26. By virtue of this architecture, if one (or more) of the inputs EF1, EF2, . . . EFi of the function FS′ is not directly available on an output of the avionics computer 12 and, consequently, cannot be acquired by the external computer 14 via the link 16, then the external computer 14 can dispatch a request to the avionics computer 12 (via the computer 24) so that it dispatches a current value of the input (corresponding to an output of one of the functions of the first subset of the set of functions) via the link 26. Indeed, the avionics computer 12 is generally envisaged to accept requests from a tests computer such as the computer 24, these requests allowing the tests computer to request the dispatching of current values of one or more internal variables of the avionics computer 12 so as to monitor these current values by means of the tests computer (for example during in-flight trials of the aircraft). Within the framework of the particular embodiment of the invention, this functionality of the avionics computer 12 is used to allow the external computer 14 to acquire inputs of the function FS′ which would otherwise not be available as output from the avionics computer 12. The link 26 between the avionics computer 12 and the external computer 14 is for example in accordance with one of the ARINC 429 or ARINC 664 standards, part 7. The link 22 between the external computer 14 and the computer 24 is, for example, of Ethernet type. The link 28 between the computer 24 and the avionics computer 12 is, for example, in accordance with one of the ARINC 429 or ARINC 664 standards, part 7. In a particular exemplary embodiment, the external computer 14 dispatches a request to the computer 24 in which it transmits a name of the input variable of the function FS′ of which it requires the dispatching of a current value. The computer 24 contains in memory a lookup table of correspondence between this name of the input variable and an address of the variable in the avionics computer 12. The computer 24, which has received the request from the external computer 14, constructs a request comprising this address corresponding to the input variable and it dispatches this request to the avionics computer 12. In response to this request, the avionics computer 12 dispatches a current value of the input variable destined for the external computer 14, via the link 26. Without departing from the scope of the invention, the external computer could also transmit a request directly to the avionics computer 12 (through a link 28′ not represented in the figure), without passing by way of the computer 24.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for developing a new version of software of an avionics computer of an aircraft,
the avionics computer being equipped with a current version of the software;
the software comprising a set of functions interconnected together and also with inputs and outputs of the avionics computer,
wherein one of the functions of the set of functions being termed a function to be updated, the function to be updated receives, as input, outputs of functions of a first subset of functions of the set of functions and provides at least one output linked to a first input of a switch of which an output is linked to one or more inputs of functions of a second subset of functions of the set of functions,
and wherein the method comprises the following steps:
hooking up to the avionics computer an external computer equipped with software comprising a new version of the function to be updated;
receiving, by the new version of the function to be updated implemented by the external computer, the outputs of functions of the first subset of functions;
dispatching, from the new version of the function to be updated implemented by the external computer, the at least one output of the function to be updated to a second input of the switch;
controlling the switch in such a way that:
in a first mode of operation, termed normal, an output of the switch corresponds to the first input; and
in a second mode of operation, termed fine tuning, the output of the switch corresponds to the second input.

2. The method according to claim 1, wherein the step comprising hooking up the avionics computer to the external computer, the external computer is hooked up to outputs of the avionics computer corresponding to outputs of functions of the first subset of functions.

3. The method according to claim 1, furthermore comprising the following steps:
dispatching, by the external computer, a request destined for the avionics computer, to request a dispatching of information corresponding to at least one output from among all outputs of functions of the first subset of functions;
in response to the request, dispatching, by the avionics computer, of the information corresponding to the at least one output, destined for the external computer;
receiving, by the external computer, the information corresponding to the at least one output.

4. The method according to claim 1, wherein the avionics computer and the external computer are installed on a test bench.

5. The method according to claim 1, wherein the avionics computer and the external computer are installed aboard an aircraft.

6. A system for developing a new version of software of an avionics computer of an aircraft, the system comprising the avionics computer, equipped with a current version of the software, the software comprising a set of functions interconnected together and also with inputs and outputs of the avionics computer,
the system comprising a switch and a computer external to the avionics computer, and wherein:
the avionics computer is configured such that one of the functions of the set of functions, termed the function to be updated, receives, as input, outputs of functions of a first subset of functions of the set of functions and provides at least one output linked to a first input of the switch of which an output is linked to one or more inputs of functions of a second subset of functions of the set of functions,
the external computer is equipped with software comprising a new version of the function to be updated, it is hooked up to the avionics computer and it is configured to:
receive, by the new version of the function to be updated implemented by the external computer, the outputs of functions of the first subset of functions;
dispatch, from the new version of the function to be updated implemented by the external computer, the at least one output of the function to be updated to a second input of the switch;
the system being configured to control the switch such that:
in a first mode of operation, termed normal, the output of the switch corresponds to the first input; and
in a second mode of operation, termed fine tuning, the output of the switch corresponds to the second input.

7. The system according to claim 6, wherein the external computer is hooked up to outputs of the avionics computer corresponding to outputs of functions of the first subset of functions.

8. The system according to claim 6, wherein:
the external computer is furthermore configured to dispatch a request destined for the avionics computer, to request the dispatching of information corresponding to at least one output from among all outputs of functions of the first subset of functions; and
the avionics computer is configured to dispatch information corresponding to the at least one output, destined for the external computer, in response to the request.

9. The system according to claim 6, wherein the system is installed on a test bench.

10. The system according to claim 6, wherein the system is installed aboard an aircraft.
